(19) United States
(12) Patent Application Publication
(10) Pub. No.: US 2020/0088982 A1
(43) Pub. Date: Mar. 19, 2020

(54) A SYSTEM AND METHOD FOR MICROSCOPY

(71) Applicant: UNIVERSITY OF TECHNOLOGY SYDNEY, Ultimo, NSW (AU)

(72) Inventors: Dayong JIN, Ultimo, NSW (AU); Peng XI, Ultimo, NSW (AU)

(21) Appl. No.: 15/746,744

(22) PCT Filed: Jul. 21, 2016
(86) PCT No.: PCT/AU2016/050651

§ 371 Date: Jan. 22, 2018

(30) Foreign Application Priority Data
Jul. 23, 2015 (AU) 2015902932

(51) Int. Cl. G02B 21/00; G01N 21/64

(52) U.S. Cl. CPC G02B 21/0024; G01N 21/6428; G01N 21/6458

(57) ABSTRACT

A system for microscopy comprising a reflector for a sample to be disposed adjacent thereto. The system comprises a radiation source for generating electromagnetic radiation and arranged for the electromagnetic radiation when so generated to pass at least partially through the sample when so disposed. When the electromagnetic radiation is so generated, interference is localized at least partially within the sample when so positioned, the interference being electromagnetic interference between the electromagnetic radiation and a reflected electromagnetic radiation that is at least part of the electromagnetic radiation reflected from the reflector.

### TECHNICAL FIELD

The present invention generally relates to microscopy, including nanoscopy, and specifically but not exclusively to a system and method for microscopy, a mount, and a kit comprising a plurality of mounts, that generally but not necessarily provide enhanced resolution, particularly but not exclusively axial resolution.

### BACKGROUND

In order to improve imaging resolution, a variety of optical microscopy techniques have been proposed. Improving image resolution may, for example, enable resolution of sub-cellular features, and increase the imaging contrast of sub-cellular fine structures against their neighbouring background. Examples of optical microscopy techniques include:
confocal microscopy, which has been broadly used in high resolution imaging of live cells and tissues because it employs pinhole detection to reject out-of-focus noise, and can attain an improved contrast by using pinhole modulation, however the axial extent of the point spread function is greater 500 nm;
stimulated emission depletion (STED) microscopy, which has recently become popular as it offers lateral resolution better than the optical diffraction limit;
total internal reflection fluorescence (TIRF) microscopy, which provides axial super-resolution for single-molecule localizations because it uses an evanescent field to image the superficial layer of the biological cell with imaging depths of ˜100 nm.

In this specification, any reference to microscopy should be understood to generally encompass nanoscopy.

### SUMMARY

Disclosed herein is a system for microscopy. The system comprises a reflector for a sample to be disposed adjacent thereto. The system comprises a radiation source for generating electromagnetic radiation. The radiation source is arranged for the electromagnetic radiation when so generated to pass at least partially through the sample when so disposed. When the electromagnetic radiation is so generated, interference is localised at least partially within the sample when so positioned. The interference is electromagnetic interference between the electromagnetic radiation and a reflected electromagnetic radiation that is at least part of the electromagnetic radiation reflected from the reflector.

In an embodiment, the interference has an irradiance maximum within the sample.

In an embodiment, the interference between the electromagnetic radiation and the reflected electromagnetic radiation produces an axial resolution in an image of the sample that is better than an axial resolution without the reflector being present.

An embodiment comprises a microscope objective arranged for focusing the electromagnetic radiation.

In an embodiment, the electromagnetic radiation comprises a laser beam.

In an embodiment, electromagnetic radiation comprises visible light.

In an embodiment, the reflector is coated by at least one layer transparent to the electromagnetic radiation.

In an embodiment, the at least one layer has a thickness of less than at least one of 3 nm, 10 nm, 25 nm and 50 nm, 100 nm and 150 nm.

An embodiment comprises a mirror comprising the reflector and the at least one layer.

In an embodiment, the sample is a growth on the at least one layer that is bio-compatible.

In an embodiment, the optical path length of the at least one layer is electrically changeable.

In an embodiment, the at least one layer comprises at least one of silicon dioxide, silicon nitride, diamond, sapphire, a piezoelectric material and liquid crystal.

In an embodiment, the electromagnetic radiation comprises an electromagnetic excitation radiation.

In an embodiment, the electromagnetic excitation radiation is for exciting fluoresce within the sample.

In an embodiment, the interference defines a point spread function.

In an embodiment, the point spread function is axially more localised than a point spread function defined without the interference.

In an embodiment, the interference is localised at an axial distance (h) away from the reflector.

In an embodiment, the axial distance (h) is between 100 nm and 150 nm.

In an embodiment, the axial extent of the interference is less that one of 150 nm, 100 nm and 50 nm.

In an embodiment, the reflector is configured to reflect more than at least one of 50% of the electromagnetic radiation, 75% of the electromagnetic radiation, 90% of the electromagnetic radiation, and 95% of the electromagnetic radiation incident thereon.

An embodiment is a laser scanning microscope.

An embodiment is for nanoscopy.

An embodiment is a Stimulated Emission Depletion nanoscope.

Disclosed herein is a mount for a sample to be examined with a system for microscopy. The mount comprises a reflector. The mount comprises at least one layer coating the reflector. The at least one layer is transparent to imaging electromagnetic radiation generated by the system for microscopy. The at least one layer has a thickness of less than 100 nm.

In an embodiment, the at least one layer has a thickness of less than at least one of 3 nm, 10 nm, 25 nm and 50 nm, 100 nm and 150 nm.

In an embodiment, the outer surface of the at least one layer is biocompatible.

In an embodiment, the optical path length of the at least one layer is electrically changeable.

An embodiment comprises at least one of silicon dioxide, silicon nitride, diamond, sapphire, a piezoelectric material and liquid crystals. Different layers may comprise different ones of silicon dioxide, silicon nitride, diamond, sapphire, a piezoelectric material and liquid crystals, for example.

Disclosed herein is a system in accordance with the above disclosure comprising a mount.

Disclosed herein is a kit. The kit comprises a plurality of mounts. Each of the plurality of mounts are for a sample to be examined with a system for microscopy. Each of the plurality of mounts comprise a reflector, and at least one layer that is transparent to imaging electromagnetic radiation generated by the system for microscopy and coats the reflector. The thickness of the at least one layer is different for each of the plurality of mounts.

In an embodiment, each of the plurality of mounts are in accordance with the above disclosure.

Disclosed herein is a method for microscopy. The method comprises the step of disposing a sample adjacent to a reflector. The method comprises the step of generating an electromagnetic radiation and passing the electromagnetic radiation at least partially through the sample. Interference is localised at least partially within the sample, the interference being electromagnetic interference between the electromagnetic radiation and a reflected electromagnetic radiation that is at least part of the electromagnetic radiation reflected from the reflector.

In an embodiment, the interference has an irradiance maximum within the sample.

In an embodiment, the interference between the electromagnetic radiation and the reflected electromagnetic radiation produces an axial resolution in an image of the sample that is better than a resolution without the reflector being present.

An embodiment comprises the step of focusing the electromagnetic radiation adjacent the reflector.

In an embodiment, the electromagnetic radiation comprises a laser beam.

In an embodiment, the electromagnetic radiation comprises visible light.

An embodiment comprises the step of passing the electromagnetic radiation through at least one layer coating the reflector.

In an embodiment, the at least one layer has a thickness of less than at least one of 3 nm, 10 nm, 25 nm and 50 nm, 100 nm and 150 nm.

An embodiment comprises the step of growing the sample on the at least one layer.

An embodiment comprises the step of electrically changing the optical path length of the at least one layer.

An embodiment comprises the step of forming the at least one layer.

An embodiment comprises the step of exciting fluorescence within the sample with the electromagnetic radiation.

In an embodiment, the interference defines a point spread function.

In an embodiment, the point spread function is axially more localised than a point spread function defined without the interference.

In an embodiment, the interference is localised at an axial distance (h) away from the reflector.

In an embodiment, the axial distance (h) is between 100 nm and 150 nm.

In an embodiment, the axial extent of the interference is less that one of 150 nm, 100 nm and 50 nm.

Disclosed herein are a system, a device, a method and a microscope for providing enhanced resolution, particularly axial resolution, of an object by utilising interference of incident and reflected electromagnetic radiation. The reflected electromagnetic radiation is reflected from a reflector, for example a mirror. The object may comprise at least one of a sample and a specimen.

Disclosed herein is a system for Mirror Enhanced Axial Narrowing Super-resolution (MEANS) Microscopy.

Disclosed herein is a method for Mirror Enhanced Axial Narrowing Super-resolution (MEANS) Microscopy.

Disclosed herein is provided a system for microscopy, comprising: a reflector, on or adjacent which a sample is able to be positioned; excitation radiation, able to be directed to and at least partially through the sample; and reflected radiation, being at least part of the excitation radiation reflected from the reflector; wherein, interference between the excitation radiation and the reflected radiation is localised and at least partially within the sample.

Disclosed herein is provided a system for microscopy, comprising: a reflector, on or adjacent which a sample is able to be positioned; excitation radiation, able to be directed to and at least partially through the sample; and reflected radiation, being at least part of the excitation radiation reflected from the reflector; wherein, interference between the excitation radiation and the reflected radiation enhances an electromagnetic radiation field at least partially within the sample.

Disclosed herein is provided a system for microscopy, comprising: a reflector, on or adjacent which a sample is able to be positioned; excitation radiation, able to be directed to and at least partially through the sample; and reflected radiation, being at least part of the excitation radiation reflected from the reflector; wherein, interference between the excitation radiation and the reflected radiation produces a point spread function of electromagnetic radiation at least partially within the sample.

Disclosed herein is provided a system for microscopy, comprising: a reflector, on or adjacent which a sample is able to be positioned; excitation radiation, able to be directed to and at least partially through the sample; and reflected radiation, being at least part of the excitation radiation reflected from the reflector; wherein, interference between the excitation radiation and the reflected radiation produces an increased axial resolution in an image of the sample compared to a resolution without the reflector being present.

In an embodiment, the system for microscopy is an optical system. An objective may be provided to direct the excitation radiation; the excitation radiation is an excitation beam. The reflected radiation may be a reflected beam. The excitation radiation may be a laser beam, and the reflected radiation may be a reflected laser beam. The reflector may be a mirror. The transparent layer may be provided on the reflector. The sample may be able to be positioned on or adjacent the transparent layer.

Additionally, or alternatively, interference between the excitation radiation and the reflected radiation is localised and at least partially within the sample. Interference between the excitation radiation and the reflected radiation may enhance an electromagnetic radiation field at least partially within the sample. Interference between the excitation radiation and the reflected radiation may produce a point spread function of electromagnetic radiation at least partially within the sample. Interference between the excitation radiation and the reflected radiation may produce an increased axial resolution in an image of the sample compared to a resolution without the reflector being present.

In an embodiment, localisation is an axial distance (h) away from the reflector. The axial distance (h) may be about 150 nm. Localisation may be of an axial extent (d) along an axial direction. The axial extent (d) may be about 100 nm. The point spread function of electromagnetic radiation may have an axial extent of about 100 nm and may be positioned about 150 nm from the reflector.

In an embodiment, the system for microscopy is a laser scanning microscope. The system for microscopy may be a system for nanoscopy. The system for nanoscopy may be a Stimulated Emission Depletion nanoscope. The reflector may be separately provided for use in the system, for example as a metal mirror with a protective layer or coating.

Disclosed herein is a system for optically detecting an object, the system comprising:
a reflector for receiving the object;
an optical system for directing an excitation electromagnetic radiation to and at least

partially through the object when so received by the reflector, wherein the reflector and the optical system are cooperatively arranged for generation of an interference between the excitation electromagnetic radiation and a reflected electromagnetic radiation, the interference being localised and at least partially within the object.

In an embodiment, the optical system is arranged to collect fluorescence stimulated within the sample by the interference for detection.

Disclosed herein is a method of enhancing axial resolution in a device for microscopy, comprising: positioning a sample on or adjacent a reflector; and directing excitation radiation at least partially through the sample, such that reflected radiation, being at least partially from the excitation radiation, is reflected from the reflector; wherein, interference between the excitation radiation and the reflected radiation is localised and at least partially within the sample.

Any of the various features of each of the above disclosures, and of the various features of the embodiments described below, can be combined as suitable and desired.

### BRIEF DESCRIPTION OF FIGURES

Embodiments will now be described by way of example only with reference to the accompanying figures in which:

FIGS. 1 and 2 show schematic diagrams of embodiments of a system for microscopy.

FIG. 3 illustrates correlative images of a single cell acquired in microscopy imaging modes of (A) TIRF; (B) MEANS; and (C) Merge.

FIG. 4 illustrates a comparison of different imaging modalities, showing: (a) confocal; (b) wide-field; (c) 4 Pi; (d) TIRF; (e) MEANS; (f) standing-wave excitation; (g) I⁵M; (h) standing-wave multiplanar excitation; (i) isotropic focusing; (j) STED-angle.

FIG. 5 illustrates theoretical simulation results of focal irradiance profiles of: (a) confocal excitation, (b) 4 Pi excitation, (c) MEANS excitation, (d) STED depletion; (e) MEANS-STED depletion.

FIG. 6 illustrates a confocal and MEANS obtained image of an example dual-stained Vero cell, where (a)-(h) are an image series taken from a confocal microscope (Olympus FV1200) with axial steps of 0.5 μm.

FIG. 7 illustrates the nuclear pore complex (NPC) of a Vero cell, (a)-(c) and (e) imaging using confocal (a; up-right) and MEANS-STED modalities, and the hRSV viral filaments imaging via conventional STED (f)-(i), and MEANS-STED (l)-(o) modalities.

FIG. 8 shows (A) a plot of the irradiance distribution along arrows in FIG. 7(c), and (B) and (C) are the irradiance plots of the line indicated by the yellow arrows in FIG. 7(i) and FIG. 6(o), respectively.

FIG. 9 illustrates modelling results of the electromagnetic field irradiance distribution for mirror-confocal excitation, with changing position of the mirror (denoted as the right dark border of each image).

FIG. 10 illustrates image z-stacks of MEANS confocal microscopy (using Olympus FV-1200, with apochromatic 60×, water immersion objective, NA=1.42). The eight sequential images are at steps of 0.5 μm away from the top surface (0 μm) towards the mirror substrate.

FIG. 11 illustrates image z-stacks of MEANS spinning disk confocal microscopy. The eight sequential images are at steps of every 0.5 μm away from the top surface (0 μm) towards the mirror substrate.

FIG. 12 illustrates example simulations.

FIG. 13 shows a comparative plot of irradiance against distance for simulations represented in FIG. 5.

FIG. 14 shows a graph of the location of irradiance maximum in an interference as a function of wavelength.

FIG. 15 shows a kit comprising a plurality of mounts.

FIG. 16 shows a flow diagram for an embodiment of a method 1100 for microscopy

### DESCRIPTION OF EMBODIMENTS

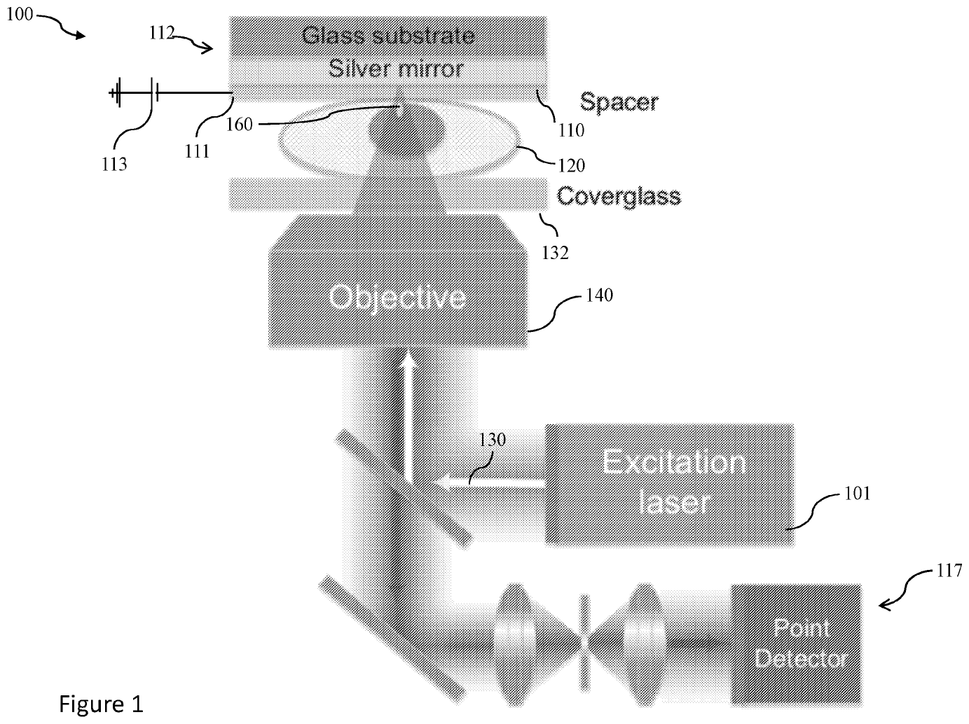

FIG. 1 shows an embodiment of a system for microscopy, the system being generally indicated by the numeral 100. The system 100 comprises a reflector 110 for a sample 120 to be disposed adjacent thereto. The system comprises a radiation source 101 for generating electromagnetic radiation 130 and arranged for the electromagnetic radiation 130 when so generated to pass at least partially through the sample 120 when so disposed. When the electromagnetic radiation 130 is so generated, interference 160 is localised at least partially within the sample when so positioned, the interference 160 being electromagnetic interference between the electromagnetic radiation 130 and a reflected electromagnetic radiation 150 that is at least part of the electromagnetic radiation 130 reflected from the reflector 110.

The sample may generally be any known type of suitable specimen, object, cell, microbiological organism, biological sample, etc.

The system 100 is for forming an image of the sample, and is in the form of a laser scanning microscope, an adapted Stimulated Emission Depletion (STED) Nanoscope, however other embodiments may take alternative forms. Generally, but not necessarily, the electromagnetic radiation 130 comprises an electromagnetic excitation radiation for exciting fluorescence within the sample. The sample may be infiltrated with fluorophores, or may naturally fluoresce without fluorophore infiltration. The at least part of the fluorescence is collected by the objective 140 for detection by a detector 117.

The reflector 110 is configured to reflect more than 95% of the electromagnetic radiation 130 incident thereon, however lower or higher reflectivities may be used. For example, the mirror may be configured to reflect more than at least one of 50%, 75% and 99% of the electromagnetic radiation. Generally, the greater the reflectivity the better the interference effect.

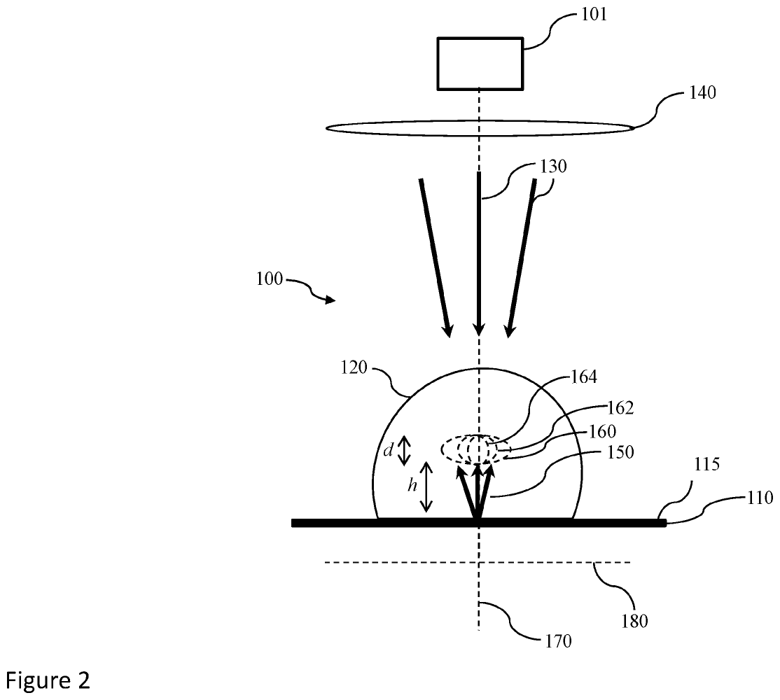

FIG. 2 shows a detail of another embodiment of a system for microscopy 1000, wherein parts similar in form and/or function to those of FIG. 1 are similarly numbered. The systems 100, 1000 are Mirror Enhanced Axial Narrowing Super-Resolution (MEANS) microscopy systems. The reflector 110 comprises a reflective surface 115.

A coverslip 132 may be positioned as is suitable and/or required over or above sample 120. An objective 140 directs and focuses radiation 130, at least partially through sample 120, towards the reflector 110. Interference 160 between the electromagnetic radiation 130 and the reflected electromagnetic radiation 150 forms an axially narrowed point spread function (PSF) 162. A point of maximum irradiance 164 results from the interference, which is localised and at least partially within sample 120.

The interference and axially narrowed PSF 162 is localised an axial distance (h) away from the reflector. The axial distance is dependent on the wavelength of the radiation 130. The axial distance (h) is about 150 nm in the embodiments of FIGS. 1 and 2. Localisation is of an axial extent (d) along an axial direction, which is also dependant on wavelength, is about 100 nm. FIG. 14 shows a graph of the location of irradiance maximum in an interference as a function of wavelength. Working in the far-field regime, the MEANS system 100 enables excitation confinement, i.e. localisation, to provide about or more than about six-fold higher axial resolution than the optical diffraction limit. The MEANS system, method or device is broadly suitable, for example as a modification, in all scanning optical microscopy systems, without introducing additional complexity and cost. The system or device can be a microscope.

The inventors have surprisingly found that the axial thickness of the confocal Point Spread Function (PSF) can be improved by replacing the common microscopy slide with a reflector. This may enable axial super-resolution in, for example, laser scanning microscopes. That is, an axial resolution in an image of the sample is better than a resolution without the reflector 110 being present. Use of reflector 110 enhanced confinement of the point spread function which may generally improve the axial resolution about six-fold and the lateral resolution about two-fold for Stimulated Emission Depletion (STED) nanoscopy, with little additional complexity. That is, the dimensions of the point spread function with the reflector 110 are around one sixth axially and one half laterally that obtained without the reflector 110, as is the case for prior art microscopy techniques. This may enable, for example, improved resolution visualization to about 19 nm resolution of the inner rim of a nuclear pore complex, and discrimination of about 120 nm hollow viral filaments.

The system 100 embodies a practical approach to enable laser scanning confocal microscopy and STED nanoscopy with improved axial resolution to achieve axial super-resolution images of the interior layer structure of cells. It should be noted that reference to ‘mirror’ in the acronym ‘MEANS’ is by way of example only, and the mirror can be any suitable reflector. The MEANS system, device and/or method provides an approach compatible with, for example, microscopes using laser scanning confocal illumination.

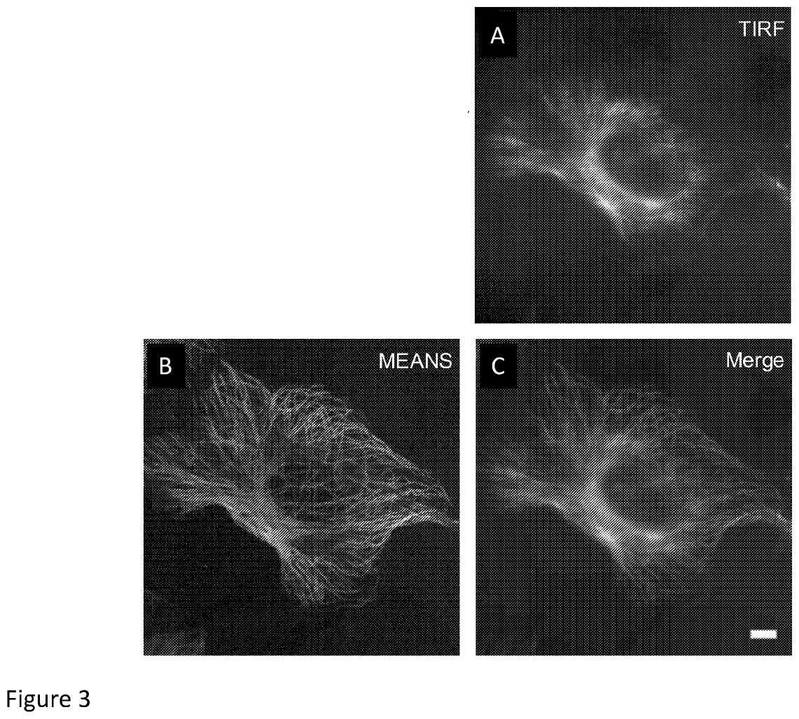

FIG. 3A to 3C are a series of in situ correlative images generated by TIRF and MEANS for a single Vero cell. While the superficial layer of the Vero cell may be imaged by TIRF modality toward a shallower axial region (FIG. 3A), the MEANS imaging modality (FIG. 3B) provides super-resolution information within an interior layer of about 110 nm axial thickness at a distance of about 150 nm away from the reflector.

The MEANS system 100 may generally, but not necessarily, be more suitable for the study of features that are not at the cell membrane, but are localized more deeply within the cell. At the nuclei of the single Vero cell, the microtubule network only exhibits at the bottom layer and is captured by the MEANS system/device providing complementary overlaid images (FIG. 3C) truly reflecting the axial relationship to TIRF imaging region. The overlaid image of TIRF and MEANS shows the MEANS approach compliments the oblique illumination based TIRF modality by optically sectioning a cell at a different axial layer. The scale bar shown is 10 μm.

Simulation of the electromagnetic field from a MEANS approach reveal that, due to interference, the local irradiance for MEANS is approximately four times that of conventional confocal microscopy, and approximately two times that of 4 Pi. As the local maximum is a result of interference, the MEANS approach can generate the local electromagnetic field enhancement over a long focal distance. This suggests that the MEANS image optically sections a fixed layer about 150 nm away from the reflector. Consequently, the MEANS modality relaxes precise alignment. The MEANS modality has only one side-lobe to generate an image with sharper contrast, whereas the PSF of 4 Pi has two symmetric side-lobes.

The electromagnetic radiation 130 is, in this but not necessarily in all embodiments, an electromagnetic radiation beam, and the reflected electromagnetic radiation 150 is a reflected beam. The electromagnetic radiation beam and the reflected electromagnetic radiation beam are in this embodiment co-axially aligned. The electromagnetic radiation 130 is in this embodiment a laser beam, and the reflected electromagnetic radiation 150 is the laser beam reflected. The laser beam is at least partially coherent, which may be required for the interference.

Optionally, as in FIG. 1 but not FIG. 2, the reflector 110 is coated by at least one layer 111 transparent to the electromagnetic radiation 130. The at least one layer 111 has a thickness of less than 50 nm, however in some embodiments the thickness is less than 100 nm. The reflector and the at least one layer may be of a mount 112 which may take the form of a mirror or silvered microscope slide, for example. The mount 112 may comprise a glass substrate which has been silvered and then coated with at least one of silicon dioxide, silicon nitride, diamond, and sapphire. The sample 120 is able to be positioned on or adjacent the transparent layer 111 if present. The reflector in FIG. 2 is a first surface mirror.

The at least on layer 111 comprises silica which is bio-compatible. The sample 120 is a growth on the at least one layer 111.

In an embodiment, the at least one layer 111 comprises at least one of a piezoelectric material and liquid crystal. The optical path length of the at least one layer is electrically changeable. A voltage 113 applied to the at least one layer 111 may be changed to the optical path length.

The system 100, 1000 comprises a laser 101 for generation of the laser beam 130. The laser is in this embodiment is a frequency doubled Nd:YAG laser, however it may be any suitable laser, examples of which include semiconductor lasers and argon ion lasers.

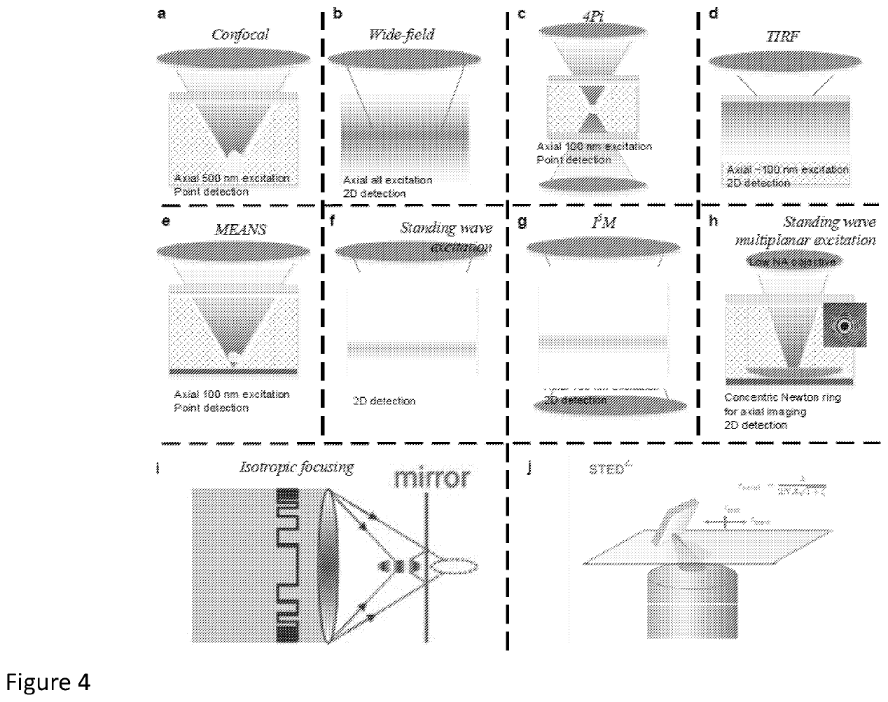

Referring to FIG. 4, there is illustrated, schematically, comparisons of the MEANS system/method with a variety of currently known axial enhanced microscopy systems/methods. MEANS can confine the axial PSF depth of confocal microscopy, for example, to about 100 nm, with doubled signal intensity. Furthermore, the MEANS system/method may compliment TIRF imaging modality by optically sectioning two different super resolution layers: TIRF is responsible for imaging the sample layer close to the coverslip while MEANS optically sections the layer that is close to the mirror (interior of the specimen). Previously, mirror-based imaging modalities have been proposed. In standing wave excitation (f), the mirror reflection provides a planar interference, which mimics I⁵M with mirror reflection. The standing-wave multi-planar excitation employs a low NA objective, a mirror, and a plan-convex lens to form Newton rings for axial imaging. The isotropic focusing mechanism utilizes a wave front modulator to generate two focal spots axially; then, a mirror is placed in between these two focal spots to form constructive interference. It is therefore critical to the position of the mirror. However, the MEANS system/method (e) is insensitive to the precise placement of the mirror, and does not require wave front modulation, as in isotropic focusing. The angle-STED (j) uses a tilted mirror to generate angled excitation, which is similar to that of the reflected light sheet microscopy, but with a STED process.

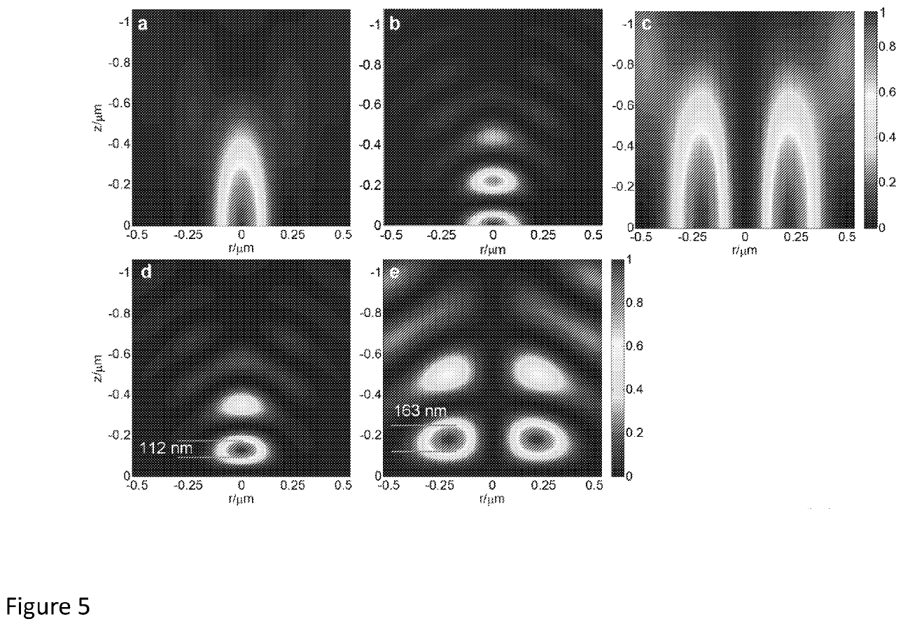

FIG. 5 illustrates theoretical simulation results of focal irradiance profiles of: (a) confocal excitation, (b) 4 Pi excitation, (c) MEANS excitation, (d) STED depletion; (e) MEANS-STED depletion. The origin of the z-axis denotes the centre of PSFs in (a)-(c), and the mirror position in (d) and (e). While confocal microscopy can generate a PSF with 700 nm axial width, the MEANS system/method can generate PSFs with about 100 nm axial width/extent, due to axial interference. An objective with n=1.5, N.A.=1.4, and excitation wavelength ₑₓ=532 nm, and depletion wavelength _{dep}=760 nm are used for the simulation. The local maximum irradiance for the MEANS system/method (d) is approximately four times that of conventional confocal microscopy (a), and approximately two times that of 4 Pi (b), since in 4 Pi the beam is split into two and then recombined, whereas the MEANS system/method takes full advantage of the incident irradiance through reflection. As the intensity of depletion is improved by about 3.6 times, close to two-fold resolution enhancement over conventional STED can be obtained for MEANS-STED, as shown in FIG. 3.

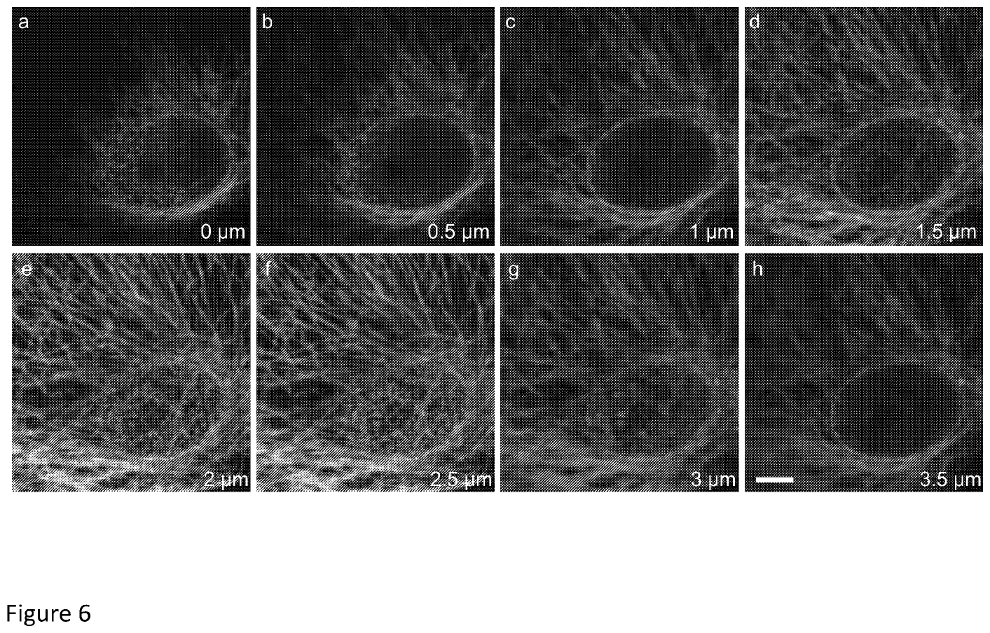

FIG. 6 illustrates a confocal and MEANS obtained image of an example dual-stained Vero cell, where (a)-(h) are an image series taken from a confocal microscope (Olympus FV1200) with axial steps of 0.5 μm. The microtubules of the example cell are stained with Dylight 650, and the nuclear pore complex of the cell is stained with Alexa 488. As can be seen, MEANS forms at 2.5 μm depth in (f), in which the nuclear pore protein is clearly observed as grains. The scale bar is 5 μm.

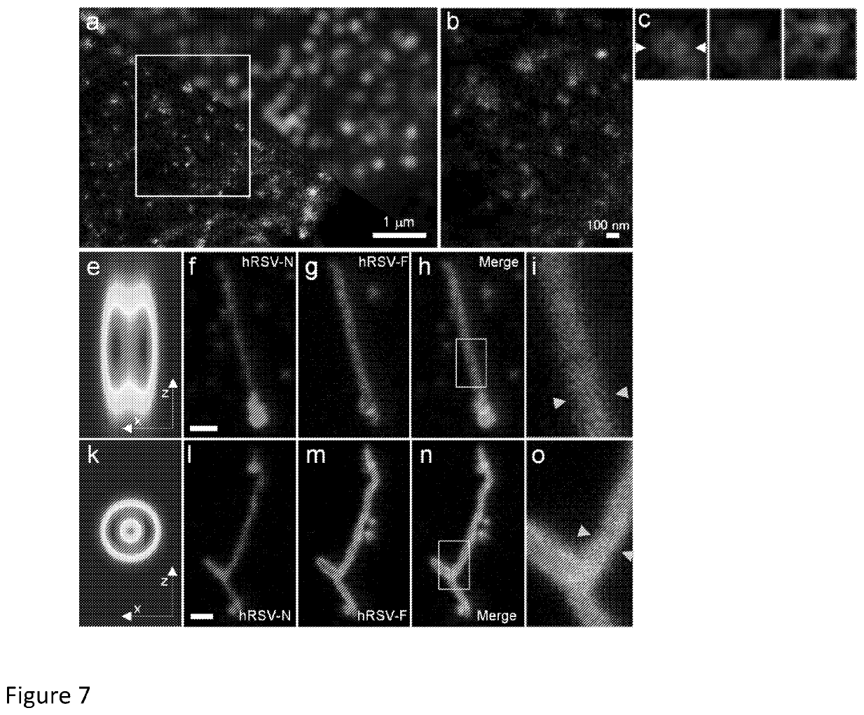

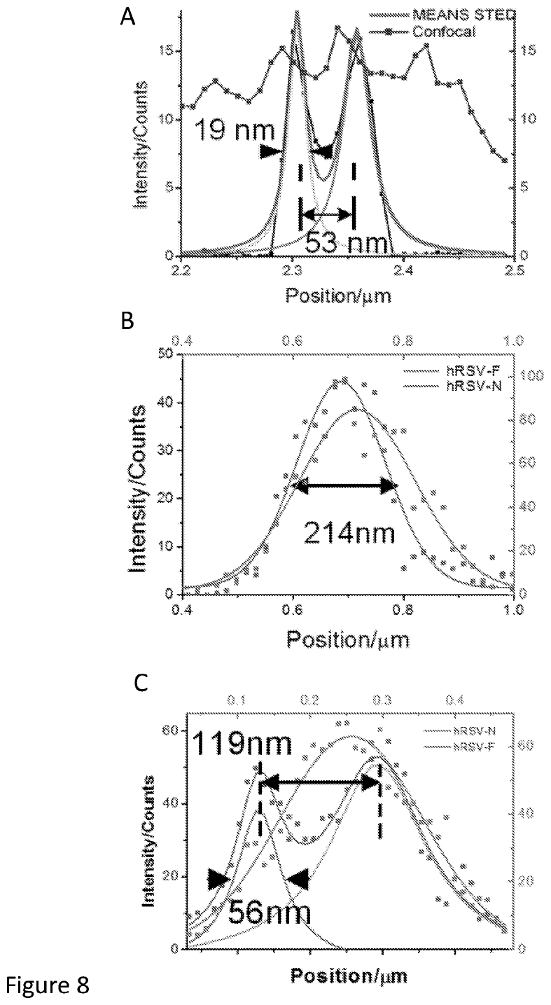

Referring to FIG. 7, the MEANS-STED combination gives lateral resolution enhancement in (a). (b) is the zoom in of the boxed area in (a), in which the porous structure of the nuclear pore complex (NPC) can be clearly seen. (c) lists the magnified individual NPCs. FIG. 8A is the plot of the irradiance distribution along arrows in (c). To demonstrate the advantage of axial confinement of MEANS-STED, the hRSV filaments are imaged with conventional STED (on cover glass, f-i) and MEANS-STED (on mirror, l-o). The simulation of the convolution of conventional STED PSF against MEANS-STED PSF with the tubule structure are shown in (e) and (k), respectively. (i) and (o) are the zoom in of the white box areas in (h) and (n), respectively. The hollow structure of the hRSV-F can be clearly visualized, taking advantage of the optical sectioning of MEANS-STED. FIGS. 8b and 8c are the irradiance plots of the line indicated by the yellow arrows in (i) and (o), respectively. The scale bar is 500 nm.

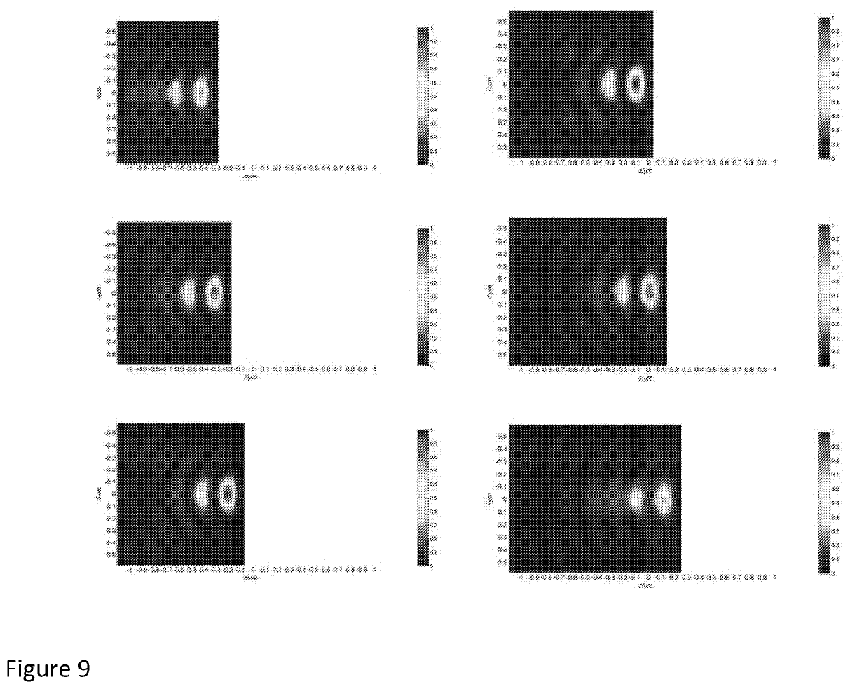

FIG. 9 illustrates modelling results of the electromagnetic field irradiance distribution for mirror-confocal excitation, with changing position of the mirror (denoted as the right dark border of each image). The 0 position denotes the location of the focal spot. As can be seen, the focal enhancement can last for 0.5 μm, due to constructive interference. The distance from the highest irradiance to the mirror is about 150 nm. For a silicon dioxide coating (refractive index n=1.5), a 100 nm protective layer (i.e. transparent layer), for example, may be applied over the reflector. The layer may comprise at least one of silicon nitride, diamond, sapphire, a piezoelectric material and liquid crystals.

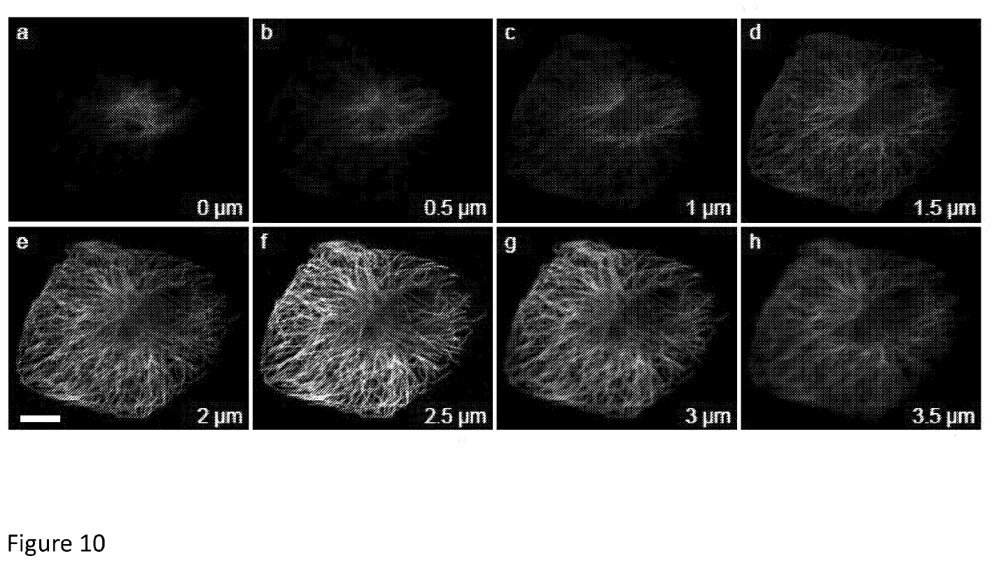

FIG. 10 illustrates image z-stacks generated by MEANS confocal microscopy (using, by way of example, an Olympus FV-1200 microscope, with an apochromatic 60× water immersion objective having a numerical aperture (NA) of 1.42). The eight sequential images are at steps of 0.5 μm away from the top surface (0 μm) towards the mirror substrate. Clearly the images (a)-(c) were the standard confocal images since those sections were still far away from the MEANS modality region. The difference between image (c) and image (d) indicated that the confocal modality was transferred to the MEANS modality so that a particular section of the cell suddenly showed up. A further four steps forward recorded the same axially focused section of microtubules but with different signal to noise contrasts shown as images (d)-(h). The image (f) has achieved maximum signal to noise contrast indicating the best interference of incident excitation beam and reflected beam. Although images (d) and (h) are at the same distance from image (f), the image (h) at a distance of 3.5 μm from the top surface is heavily blurred as a result from the multiple interference arises when the focal spot is too close to the mirror. Whereas the focal spot is far away from the mirror, the axial PSF reduces to the standard confocal PSF so that the image quality of images (a)-(d) was achieved at confocal axial resolution. The scale bar is 10 μm.

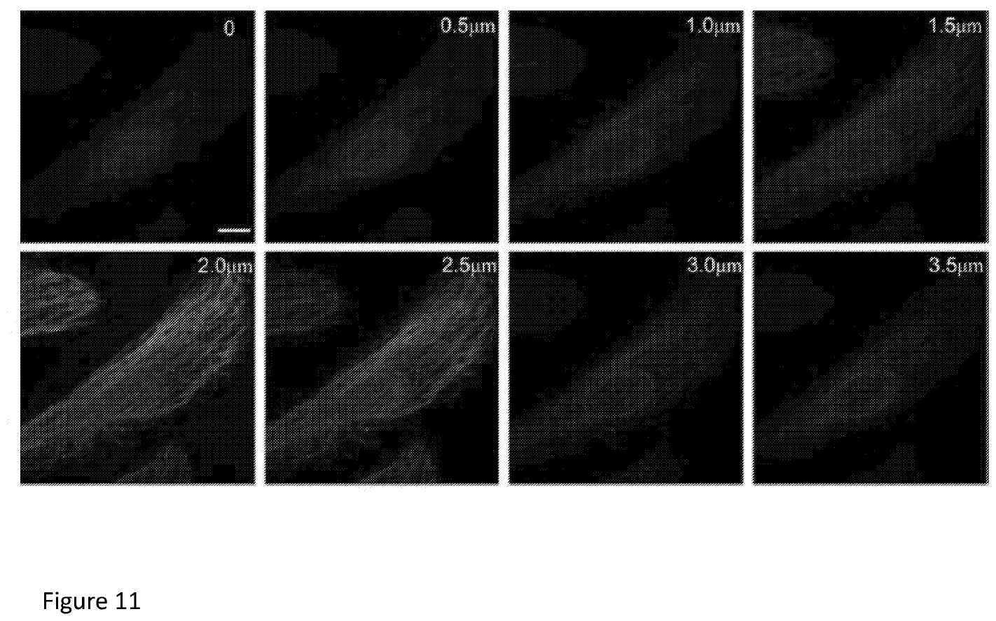

FIG. 11 illustrates image z-stacks generated by MEANS spinning disk confocal microscopy. The eight sequential images are at steps of every 0.5 μm away from the top surface (0 μm) towards the mirror substrate. The images 0 μm-1.5 μm are the standard confocal images because those sections were still far away from the MEANS modality region. The difference between the image (at 1.5 μm) and the image (at 2.0 μm) indicated that the confocal modality was transferred to the MEANS modality so that a particular section of the cell suddenly showed up. The image (at 2.0 μm) achieved maximum signal to noise contrast indicating the best interference of incident excitation beam and reflected beam. Although images (at 1.5 μm) and (at 2.5 μm) are at the same distance from image (at 2.0 μm), the images at a distance of 3.0 μm and 3.5 μm from the top surface is heavily blurred as a result from the multiple interference arises when the focal spot is too close to the mirror. The scale bar is 10 μm.

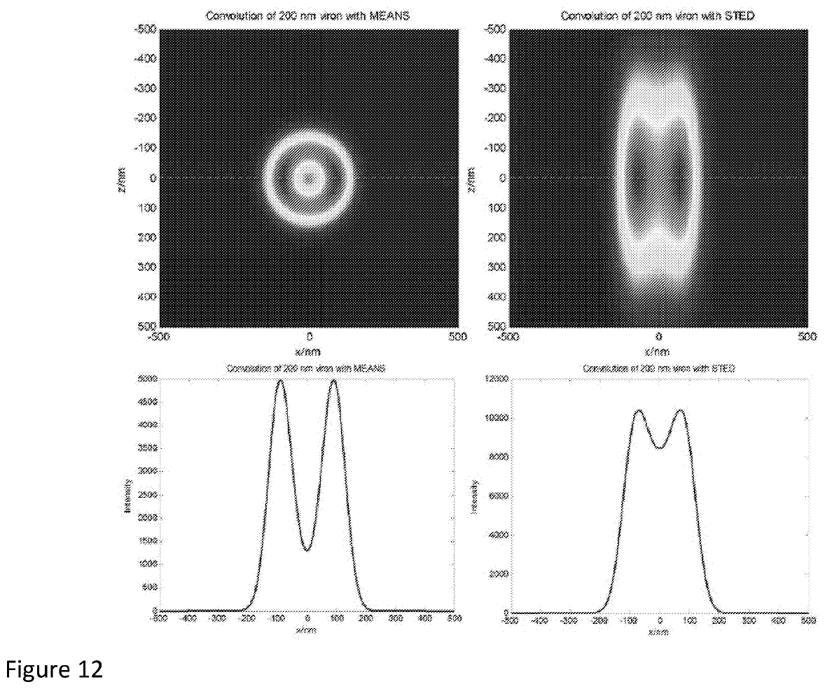

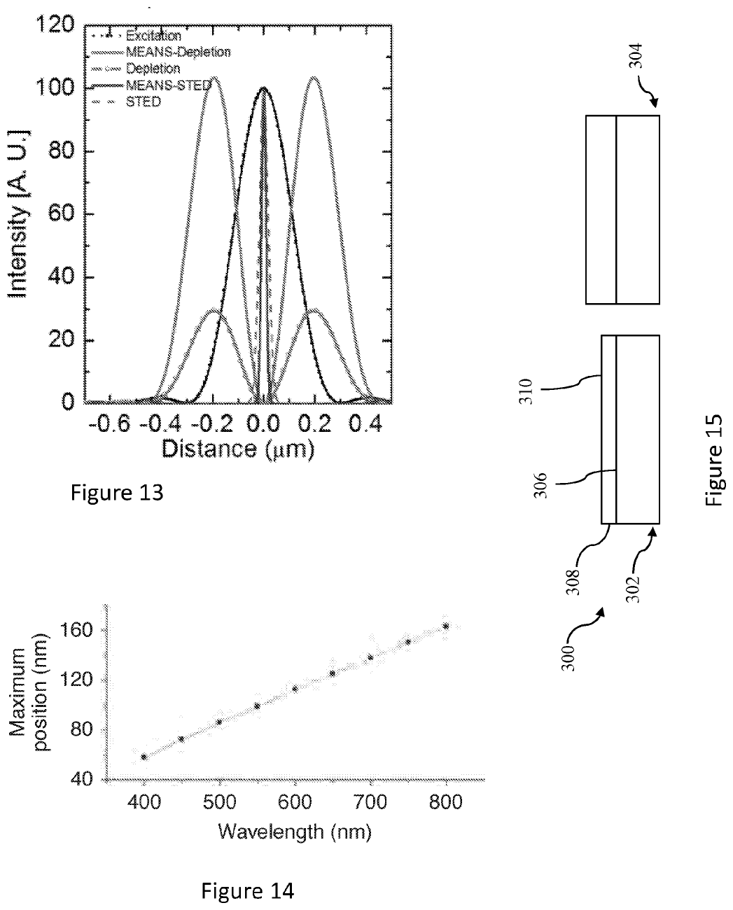

FIG. 12 illustrates example simulations to highlight the importance of axial resolution enhancement, for example in resolving the hollow structure of viral filaments. As the viral filament F protein on the viral envelope is a tube-like hollow structure, the upper and lower boundaries of the tube can decrease the contrast using the conventional STED with axial resolution more than 500 nm. To understand how the size of axial PSF may affect the visualization of hollow viral filaments, a filament with diameter of 200 nm and with membrane thickness of 50 nm is simulated. In the simulations, it is assumed the same lateral resolution of 40 nm can be achieved by both conventional STED (right side figures) and MEANS-STED (left side figures), but different axial resolutions of 500 nm and 100 nm for STED and MEANS-STED, respectively. As the collected fluorescence signal is a convolution of the structure of the filament with the corresponding PSF, the conventional STED fails in providing sufficient contrast to suppress the upper and lower membranes of the 120 nm hollow structure, but the MEANS modality at the same lateral resolution of 40 nm can clearly resolve the hollow structure.

FIG. 15 shows a kit 300 comprising a plurality of mounts 302, 304 that may each be used with the system 100, 1000. Each of the plurality of mounts 302, 304 are for a sample to be examined with a system for microscopy 100, 1000. Each of the plurality of mounts 302, 304 comprise a reflector 306, and at least one layer 308 that is transparent to imaging electromagnetic radiation 130 generated by the system for microscopy 100, 1000 and coating the reflector 306. The thickness of the at least one layer 308 is different for each of the plurality of mounts. Similar cells may be placed on the plurality of mounts 302, 304. Because the distance of the point spread function from the outer surface 310 adjacent the reflector 306 is different for each of the plurality of mounts 302, 304, slices within similar sample at different distances from the surfaces 310 can be obtained. Consequently, the nature of the structure of any one of the similar samples along the axis may be inferred.

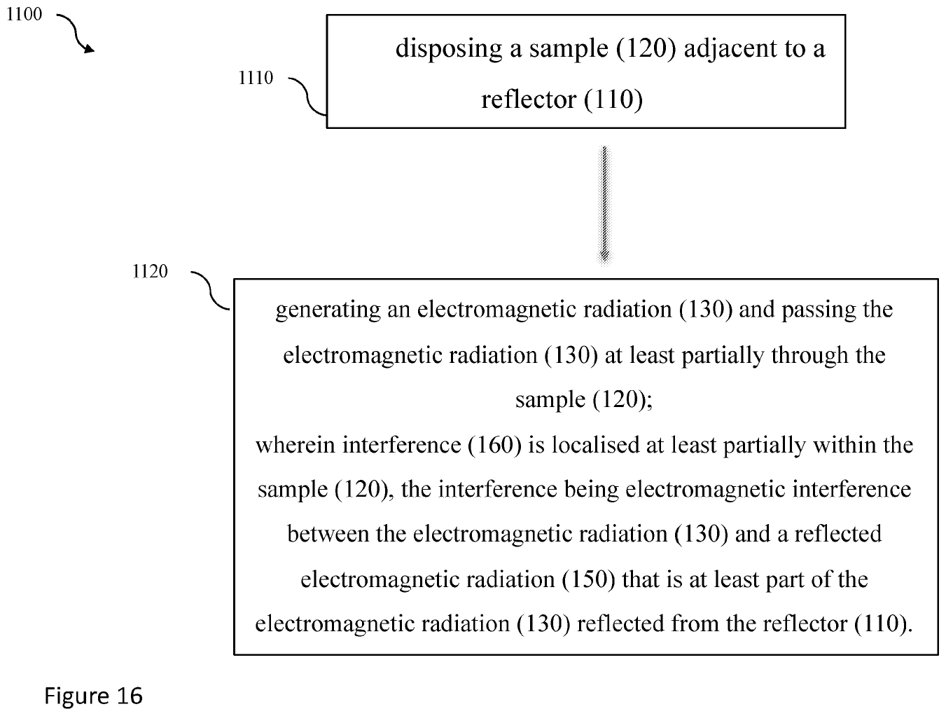

FIG. 16 shows a flow diagram for an embodiment of a method 1100 for microscopy that may be performed using the system 100, 1000. A step 1110 comprises disposing a sample (120) adjacent to a reflector (110). A step 1120 comprises generating an electromagnetic radiation (130) and passing the electromagnetic radiation (130) at least partially through the sample (120). Interference (160) is localised at least partially within the sample (120), the interference being electromagnetic interference between the electromagnetic radiation (130) and a reflected electromagnetic radiation (150) that is at least part of the electromagnetic radiation (130) reflected from the reflector (110).

Further examples

The following examples provide a more detailed discussion of particular example embodiments.

The examples are intended to be merely illustrative and not limiting to the scope of the present invention.

To further verify results and demonstrate the robustness of MEANS modality, the MEANS system/method was applied to a commercial point-scanning confocal microscope (see FIG. 6) and a spinning-disk microscope (See FIG. 11). A series of images were acquired along z direction of the microtubules of a Vero cell grown on the mirror substrate (see FIG. 10). These quantitative imaging results indicate that the MEANS-confocal modality has a tolerant region of about 1 μm to section an axially confined thin layer of the cell, at about 150 nm away from the mirror, which is consistent with simulation results (see FIG. 9). Comparing the MEANS image (see FIG. 10f) to the confocal images (FIG. 10a-c), clearly the MEANS system/method with enhanced excitation intensities by interference can significantly enhance the image SNR through increased fluorescence signal intensity.

Another significant advantage of MEANS modality lies in its compatibility with the modern super-resolution STED technique. According to simulation results (see FIG. 5d and e), the local electromagnetic field for the vortex-modulated “doughnut” STED PSF has also been axially confined to form a 163 nm MEANS-STED depletion PSF. Therefore, the irradiance of the donut-shaped depletion beam has been enhanced by about 3.6 times within the MEANS region. The resolution of STED super-resolution is dependent on the depletion intensity, which can be written as:

$$d = \frac{ }{2 NA} \frac{1}{\sqrt{1 + {I}_{dep} / {I}_{sat}}}$$

where I_{dep} is the depletion intensity, and Iₛₐₜ is the saturation intensity of the molecule. As a result, the constructive interference in MEANS-STED mode provides close to two-fold resolution enhancement over conventional STED.

To verify the MEANS system/method in STED nanoscopy, the MEANS system/method was applied in the commercial Leica TCS SP8 STED 3×super resolution microscope without additional complexity or cost added to the system. As a result of the MEANS assisted STED as shown in FIG. 7a-d, a 19 nm resolution was achieved to visualize the fine inner rim of the NPCs (radius of 26.5 nm) using a relatively low 592 nm depletion laser power of 60 mW measured at the back aperture of the objective. The NPC, restricting the diffusion of proteins and mRNAs between the nucleoplasm to the cytoplasm, is composed of three concentric rings held together by linker nucleoporins (Nups) proteins, whereas the phenylalanine-glycine (FG) Nups are at the centre. Because of the small diameter of Nup62, its ring structure has been only revealed by electron microscopy from an isolated Nup62 complex, whereas under other super-resolution microscopes such as dSTORM, its ring structure is unresolvable.

After the inner side (including Nup62, Nup95, and Nup110 proteins) of the NPCs are stained, the MEANS system/method implemented on a commercial STED system enabled a record of one of the first optical images of an FG Nup in a mammalian cell (FIG. 7a-d). The measured diameter relative to the size of the whole nuclear pore complex confirms that the antibody was indeed bound to Nups in the centre of the NPC.

The axial super resolution achieved by the MEANS system/method has further assisted STED for 3-D super resolution visualization of the sub-micron hollow structures. The filamentous hRSV RNA virus particles are tube-core-like structures with the distance between the centroid of the hRSV-F proteins measured as about 120 nm, and play an important role in human respiratory syncytial virus (hRSV), influenza, and Ebola infections. The F protein was stained on the viral envelope by AlexaFluor 488, and the inside N protein by Dylight 650. Despite using even higher STED depletion power (108 mW at 592 nm) than the MEANS-STED (72 mW), the conventional STED with the axial PSF of over 500 nm cannot resolve the F proteins due to the presence of the upper and lower border of the viron filament lumen. However, in contrast, applying the MEANS system/method, FIG. 7l-o clearly reveal that the F protein on the viral envelope surrounds the inside N protein (FIG. 6n).

Remarkably, due to the fact that the axial light confinement occurs about 150 nm away from the reflector, which may be a metal surface, the MEANS system/method is immune to quenching at the reflective (e.g. metal) surface. The working distance for the MEANS system/method super-resolution can therefore be adjusted by customizing the thickness of a coating layer over the reflector, for example a silica coating, which is a standard procedure for commercial protective mirrors. Growing the cell on a coated layer of silica rather than directly on a metal reflector provides a more compatible environment for cell growth.

Notably, the MEANS system/method is broadly applicable to other optical systems requiring PSF engineering, including the pulsed or time-gated STED, RESOLFT, ground state depletion, excitation state absorption, saturation, optical lithography, up-conversion, etc. Compared to other imaging techniques based on the recollection of the signal through interference, the MEANS system/method is much simpler and immune to precise alignment. However, the MEANS system/method, similar to TIRF, cannot generate a 3-D optical sectioning of the specimen, unlike 4 Pi and reflected light sheet microscopy. Also, the MEANS system/method is compatible with conventional sample preparation procedures, which is advantageous over virtual imaging.

Sample Preparation

In present embodiments, a mirror can be employed in place of a microscope slide. Custom-made mirrors were used. The mirror is coated with a protective layer, for example a SiO₂ coating less than 100 nm, so that the constructive interference for a high N.A. objective can occur inside the sample/specimen. Due to the existence of the biocompatible silica layer, cells can grow normally on the mirror surface. A coverslip can be applied to seal the specimen. A mirror holder with the same size as a microscope slide can be prepared, so that it can be easily placed on any commercial confocal microscope.

Cellular Sample Preparation

Vero cells (ATCC CCL-81) were maintained in High Glucose DMEM (Lonza) with 10% FBS (Hyclone), 100 U ml-1 penicillin, and 100 μg ml⁻¹ streptomycin (Invitrogen). hRSV strain A2 (ATCC VR-1544) was propagated in HEp-2 cells (ATCC CCL-23) at a titer of 1×10⁶ pfu/mL. Cells were plated the day before infection at 25% confluency. Cells were infected by removing the media, washing with PBS (without Ca²⁺ and Mg²⁺), adding virus at a multiplicity of infection (MOI) of 1, and incubating the cells for 1 h at 37° C. After adsorption, fresh medium was added to the inoculum. The cells are grown on top of a first-surface mirror, coated with SiO₂ protective layer, so that the cells can grow on top of the SiO₂ layer. Vero cells were fixed with either 4% paraformaldehyde in PBS for 10 min at room temperature and then permeabilized with 0.2% Triton X-100 (for nuclear pore complex staining) or fixed with 100% ice-cold methanol for 10 min at −20° C. and then permeabilized with 100% ice-cold acetone for 2 min at −20° C. (for microtubule staining). Nonspecific antibody binding was blocked with 5% bovine serum albumin (EMD) in PBS for 30 min at 37° C. Veros were then incubated with a primary antibody for 30 min at 37° C., washed twice in PBS, and incubated with a secondary antibody for 30 min at 37° C., washed twice in PBS, and mounted in a mixture of Mowiol 4-88 (Sigma) and DABCO (VWR). Primary antibodies used were rabbit anti-alpha tubulin (polyclonal IgG, Abcam catalog: ab18251) and mouse anti-NPC proteins that contain FXFG repeats (monoclonal IgG, Abcam catalog: ab24609). Secondary antibodies used were goat anti-rabbit DyLight 650 (Pierce) and donkey anti-mouse AlexaFluor 488 (Life Technologies).

Spin capture of RSV filaments on glass. In order to capture single hRSV filamentous virions on glass, hRSV A2 was propagated in HEp-2 cells at an MOI of 0.1. At 4 days p.i., the cell-associated and supernatant fractions were scraped, freeze-thawed, and spun through 5 μm- and 0.45 μm-pore-size centrifugal filters (Millipore) at 5,000×g and 4° C. for 4 min and 1 min, respectively. The fraction between 0.45 μm and 5 μm in diameter was collected and immobilized onto a poly-L-lysine (Sigma)-coated first-surface mirror or cover glass by adsorption of 500 μL of filtered virus for 2 hr at 4° C. The immobilized virions were fixed using 4% paraformaldehyde and immuno-stained according to the aforementioned protocol. Antibodies used were anti-RSV F monocalonal (palivizumab, MedImmune) and anti-RSV N monoclonal (clone B023, Abcam). Coverslips were mounted in a mixture of Mowiol and DABCO (VWR).

The MEANS-STED based imaging was performed with a Leica TCS SP8 STED 3× system equipped with a white light laser as excitation, and 592 nm and 660 nm for STED depletion. The HyD detector and 100× oil-immersion objective (N.A. 1.4) were employed. Time-gated detection was also used, in which for AlexaFluor-488 the detection is delayed 0.5 ns, whereas for CY5 the detection is delayed 1 ns.

Variations and/or modifications may be made to the embodiments described without departing from the spirit or ambit of the invention. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A system for microscopy comprising:
a reflector for a sample to be disposed adjacent thereto;
a radiation source for generating electromagnetic radiation and arranged for the electromagnetic radiation when so generated to pass at least partially through the sample when so disposed;
wherein, when the electromagnetic radiation is so generated, interference is localized at least partially within the sample when so disposed, the interference being electromagnetic interference between the electromagnetic radiation and a reflected electromagnetic radiation that is at least part of the electromagnetic radiation reflected from the reflector.

2. A system defined by claim 1, wherein the interference has an irradiance maximum within the sample.

3. A system defined by claim 1 wherein the interference between the electromagnetic radiation and the reflected electromagnetic radiation produces an axial resolution in an image of the sample that is better than a resolution without the reflector being present.

4-6. (canceled)

7. A system defined by claim 1, wherein the reflector is coated by at least one layer transparent to the electromagnetic radiation.

8. A system defined by claim 7 wherein the at least one layer has a thickness of less than 50 nm.

9. A system defined by claim 8 wherein the thickness is less than 100 nm

10-17. (canceled)

18. A system defined by claim 1 wherein the reflector is configured to reflect more than at least one of 50% of the electromagnetic radiation, 75% of the electromagnetic radiation, 90% of the electromagnetic radiation, and 95% of the electromagnetic radiation incident thereon.

19. A system defined by claim 1 that is a laser scanning microscope.

20. A system defined by claim 1 that is for nanoscopy.

21. A system defined by claim 20 that is a Stimulated Emission Depletion nanoscope.

22-31. (canceled)

32. A method for microscopy, the method comprising the steps of:
disposing a sample adjacent to a reflector;
generating an electromagnetic radiation and passing the electromagnetic radiation at least partially through the sample;
wherein interference is localized at least partially within the sample, the interference being electromagnetic interference between the electromagnetic radiation and a reflected electromagnetic radiation that is at least part of the electromagnetic radiation reflected from the reflector.

33. A method defined by claim 32 wherein the interference has an irradiance maximum within the sample.

34. A method defined by claim 32 wherein the interference between the electromagnetic radiation and the reflected electromagnetic radiation produces an axial resolution in an image of the sample that is better than a resolution without the reflector being present.

35-37. (canceled)

38. A method defined by claim 32 comprising the step of passing the electromagnetic radiation through at least one layer coating the reflector.

39. A method defined by claim 38 wherein the at least one layer has a thickness of less than 150 nm.

40-41. (canceled)

42. A method defined by claim 38 comprising the step of electrically changing the optical path length of the at least one layer.

43-46. (canceled)

47. A method defined by claim 32 wherein the interference is localized at an axial distance (h) away from the reflector.

48. A method defined by claim 47 wherein the axial distance (h) is between 100 nm and 150 nm.

49. A method defined by claim 32 wherein the axial extent of the interference is less that one of 150 nm, 100 nm and 50 nm.

50. (canceled)
